(19) United States
(12) Patent Application Publication
(10) Pub. No.: US 2009/0325537 A1
(43) Pub. Date: Dec. 31, 2009

(54) METHOD AND DEVICE FOR CONTINUING EMERGENCY CALL IN WIRELESS NETWORK

(76) Inventor: Jing Liu, Shanghai (CN)

Correspondence Address: HARNESS, DICKEY & PIERCE, P.L.C., P.O. BOX 8910, RESTON, VA, 20195, US

(21) Appl. No.: 12/310,357

(22) PCT Filed: Aug. 14, 2007
(86) PCT No.: PCT/CN2007/002448

§ 371 Date: May 11, 2009

(30) Foreign Application Priority Data
Aug. 24, 2006 (CN) 200610030431.8

(51) Int. Cl. H04M 11/04

(52) U.S. Cl. 455/404.1

(57) ABSTRACT

The objective of the invention is to provide a method and device for the continuity of the emergency call. According to the technical solution provided by the present invention, the emergency center sends notifying messages for emergency calls to the user equipments, and the notifying messages for emergency call comprise emergency call-related information. According to the emergency call-related information, after the handoff occurs, the user equipment generates a request message for continuity of emergency call to realize the continuity of emergency call.

### FIELD OF THE INVENTION

The invention relates to wireless network, and particularly to method and corresponding device for continuing emergency call in wireless network.

### BACKGROUND OF THE INVENTION

In IP Multimedia Subsystem (IMS)/Multimedia Domain (MMD) applications, users are usually in mobile state, and the situation, that the calling user moves from a wireless network, such as WLAN, to a circuit switched domain (CS Domain), often occurs, that is, the handoff has occurred. Here, the Voice Call Continuity (VCC) is needed.

Here, we divide the voice calls into two types: emergency call and ordinary call. Emergency call, such as 110 in China and 911 in America can be performed even if the user is shutdown because of owing fee; and ordinary call is a general term for all calls except the emergency call.

In the prior art, the continuity of the ordinary call has already been well supported, which relies on the VCC application server and Serving-Call Session Control Function (S-CSCF) module. The move of User Equipment (UE) results in the handoff from WLAN to the circuit switched domain, and after that, the UE sends a call continuity request message, such as the A1-interface message. Such message includes a specific prefix (specific code) and the routing number of the VCC application server, so that the handoff call can be routed to the VCC application server. The call continuity request message does not include the real called number, for example, the logic number of the called party.

The prior art does not design specific continuing solution for emergency call; therefore, the continuity can only be performed based on the aforementioned solution. However, since the emergency number is not included in the call continuity request message, MSC (mobile switching center) can not route this handoff to the VCC application server, then, because of lack of related routing information, the MSC can not route the call to the emergency center finally, and the continuity of emergency call fails.

Furthermore, since the called number, such as 119, is not included in the call continuity request message, MSC can not recognize that the call is an emergency call. Therefore, if the user is in shutdown state because of owing fee, MSC will reject to continue the call.

Since the existing call continuity method does not support continuity of emergency call; therefore, a brand new method should be devised for emergency call.

### SUMMARY OF THE INVENTION

One object of the invention is to provide a method and device for continuing the emergency call in wireless network.

According to the first aspect of the invention, there is provided a method, in the user equipment in wireless communication network, for continuing proceeding emergency calls, said method comprises the following steps: judging whether said user equipment moves from a first type of wireless network to a second type of wireless network; if said user equipment moves from the first type of wireless network to the second type of wireless network, generating a request message for continuity of emergency call, which comprises the emergency call-related information; and sending said request message for continuity of emergency call to a network device, to which said user equipment belongs in the second type of wireless network;

According to the second aspect of the invention, there is provided an emergency call continuing device, in the user equipment in wireless communication network, for continuing proceeding emergency calls, comprising: a judging means, for judging whether said user equipment moves from a first type of wireless network to a second type of wireless network; a generating means, for if said user equipment moves from the first type of wireless network to the second type of wireless network, generating a request message for continuity of emergency call, which comprises the emergency call-related information; and a sending means, for sending said request message for continuity of emergency call to a network device, to which said user equipment belongs in the second type of wireless network;

According to the third aspect of the invention, there is provided a method, in the emergency call control device in wireless communication network, for aiding the continuity of the proceeding emergency calls, comprising the steps of: receiving an inquiry message for emergency call from a user equipment; sending a notifying message for emergency call to said user equipment, said notifying message for emergency call comprises emergency call-related information.

According to the fourth aspect of the invention, there is provided a continuity aiding device, in the emergency call control device in wireless communication network, for aiding the continuity of the proceeding emergency calls, comprising: a receiving means, for receiving an inquiry message for emergency call from a user equipment; a sending means, for sending a notifying message for emergency call to said user equipment, said notifying message for emergency call comprises emergency call-related information.

With the application of the technical solution provided by the present invention, the continuity of the emergency call can be realized for the proceeding emergency call, when mobile users move from first type of networks coverage to second type of networks.

### BRIEF DESCRIPTION OF THE DRAWINGS

Other features, objects and advantages of the present invention will become more apparent from reading the following detailed description of the non-limiting embodiments together with the accompany drawings:

FIG. 1 is a schematic view of network for continuing the proceeding emergency call, according to a detailed embodiment of the present invention;

FIG. 2 shows a flow chart of method, in the UE in wireless communication network, for continuing the proceeding emergency call, according to a detailed embodiment of the present invention;

FIG. 3 shows a block diagram for an emergency call continuing device, in the UE in wireless communication network, for continuing the proceeding emergency call, according to a detailed embodiment of the present invention;

FIG. 4 shows a flow chart of method, in the emergency call control device in wireless communication network, for aiding the continuity of the proceeding emergency call, according to a detailed embodiment of the present invention;

FIG. 5 shows a block diagram for the continuity aiding device, in the emergency call control device in wireless communication network, for aiding the continuity of the proceeding emergency call, according to a detailed embodiment of the present invention.

### EMBODIMENT OF THE PRESENT INVENTION

Explanations will first be given to the following terms,
Emergency call-related information: it comprises emergency call routing information, and preferably comprises emergency call indication information;
Emergency call routing information: it is the routing number of the emergency call control device, such as emergency center. With the routing number, MSC can successfully route the continuity request message to the emergency center;
Emergency call indication information: it comprises emergency number and/or emergency call identification. Through the emergency number and/or emergency call identification, MSC can acknowledge that whether the call belongs to emergency call. The detailed description will be given as follows in combination with the drawings.

A more detailed description will be given as follows in combination with the drawings.

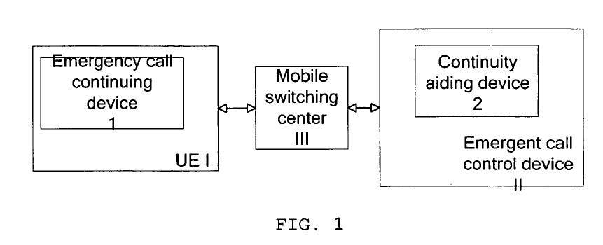

FIG. 1 is a schematic view of network for continuing the proceeding emergency call, according to a detailed embodiment of the present invention. Wherein, for simplicity, only a UE I, an emergency center II and a mobile switching center (MSC) III are shown. Those skilled in the art can understand, since the invention just relates to the improvements of the emergency center and UE and the invention is transparent for other network devices, other network devices are not shown in the drawing.

Wherein, the UE I comprises an emergency call continuing device 1, and correspondingly, the emergency call control device II comprises a continuity aiding device 2.

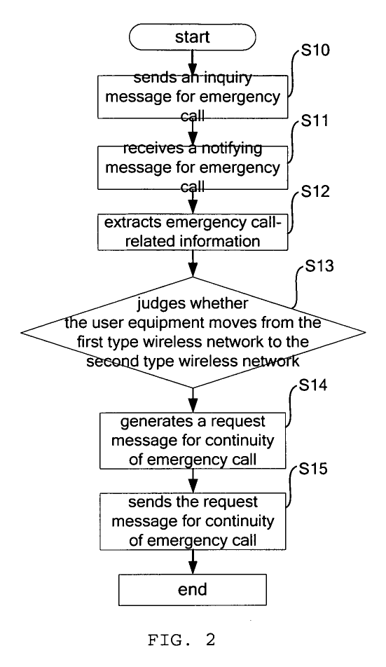

Referring to FIG. 2 and in combination with FIG. 1, the detailed description for the method, in UE I, for continuing the proceeding emergency call is given. FIG. 2 shows a flow chart of method, in the UE in wireless communication network, for continuing the proceeding emergency call, according to a detailed embodiment of the present invention. The method starts with step S10:

In step S10, the UE I, which is making a emergency call, for example the emergency call has already been set up in a first type of network (such as wireless local area network, WLAN), sends an inquiry message for emergency call to the emergency center II (of course, the message should be forwarded by corresponding network devices, but the procedure is transparent for those network devices). Via the message, the emergency center II acknowledges that UE I needs to obtain a notifying message for emergency call, such as the SIP specific event notification: SIP subscribe; then the method enters step S11;

In step S11, the UE I receives the notifying message for emergency call from the emergency center II. The message comprises the routing number of the emergency center, and preferably, further comprises the emergency number, such as 110, and/or emergency call identification. Then the method proceeds with step S12;

Here, since the emergency center II may directly sends the notifying message for emergency call to UE I, which has already set up emergency call in the first type of wireless network (such as WLAN), without needing to wait for the inquiry message for emergency call from the UE I, it is understandable that step S10 is optional;

In step S12, the UE I extracts emergency call-related information from the notifying message for emergency call. Here, although the drawing doesn't show, those skilled in the art can understand that UE I stores the extracted emergency call-related information, and uses it to generate request message for continuity of emergency call after handoff occurs; then, the method enters step S13;

Here, considering one special situation, that is, UE I pre-stores the emergency call-related information, and generates said request message for continuity of emergency call according to the pre-stored emergency call-related information each time the handoff occurs. Therefore, understandably, step S11 and S12 are also optional.

In step S13, UE I judges whether it moves from the first type of network, such as a WLAN, to a second type of network, such as a circuit switched domain network. To be specific, the UE I can send a detecting signal, such as a ranging signal, periodically/non-periodically and actively/passively, and judge whether itself has moved out of the first type of network, based on the feedbacks. Once the UE I has moved out of the coverage of the first type of network, i.e., the handoff from the first type of network to the circuit switched network has occurred, the continuity of the emergency call is needed; therefore, the method enters step S14;

Then in step S14, the UE I generates a request message for continuity of emergency call, for example, an A1-interface message. Said request message for continuity of emergency call comprises emergency call-related information, and the contents of said emergency call-related information have the following several cases, which are discussed respectively as follows:

Case 1: it Only Comprises Emergency Call Routing Information (The Routing Number of the Emergency Center)

In this case, after the request message for continuity of emergency call sent by UE I reaches MSC (also, the message is forwarded by related network device, for the same reason, without going to details), although MSC can not determine whether the call is emergency call or not, it can successfully routes the message to the emergency center since the message comprises the routing number of the emergency center. When the user is in shutdown state because of owing fee, etc, after MSC receives the request message for continuity of emergency call that only comprises the routing number of the emergency center, MSC rejects the continuity request since the user is in shutdown state and MSC can not determine whether the call is an emergency call or not, which leads to the failure of the continuity of the emergency call; when the user is not shutdown, MSC routes the request message for continuity of emergency call to the emergency center according to the routing number of the emergency center. Obviously, the emergency indication information in the request message for continuity of emergency call is optional.

Case 2: it Comprises Emergency Call Routing Information and Emergency Call Indication Information

The emergency call indication information in this case has been mentioned above, and it comprises emergency number, such as 110, and/or emergency call identification. MSC can distinguish that the call is an emergency call according to the emergency number or emergency call identification, and thus the MSC still enables the continuity of the call when the user is in shutdown state.

After the request message for continuity of emergency call is generated, the method enters step S15;

In step S15, the UE I sends the generated request message for continuity of emergency call to the network device, to which it belongs, for example a base station, in the second type of wireless network, in which it is currently located.

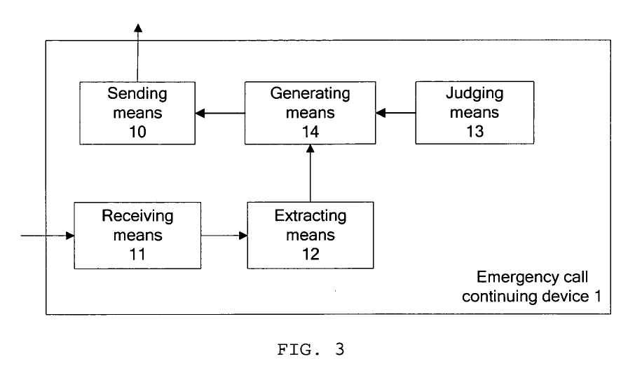

FIG. 3 shows a block diagram for an emergency call continuing device, in the UE in wireless communication network, for continuing the proceeding emergency call, according to a detailed embodiment of the present invention. Said emergency call continuing device 1 comprises: a sending means 10, a receiving means 11, an extracting means 12, a judging means 13 and a generating means 14.

The UE I making the proceeding emergency call, for example the emergency call which has already been set up in the first type of network, sends an inquiry message for emergency call to emergency center II via the sending means 10 in the emergency call continuing device 1 (of course, the message should be forwarded by corresponding network devices, but the procedure is transparent to those network devices). Via the message, the emergency center II acknowledges that UE I needs to obtain a notifying message for emergency call, such as the SIP specific event notification: SIP subscribe;

The receiving means 11 receives the notifying message for emergency call from the emergency center II. The message comprises the routing number of the emergency center, and preferably, further comprises the emergency number, such as 110, and/or emergency call identification. Then the receiving means 11 delivers the received notifying message for emergency call to the extracting means 12;

Here, since the emergency center may directly sends the notifying message for emergency call to UE I, which has already set up emergency call in the first type of wireless network (such as WLAN), without needing to wait for the inquiry message for emergency call from UE I, understandably, whether the sending means 10 sends the inquiry message for emergency call to the emergency center II is optional;

The extracting means 12 extracts the emergency call-related information from the notifying message for emergency call received by the receiving means 11. Here, although the drawing doesn't show, those skilled in the art can understand that UE I further comprises a storing means, for storing the extracted emergency call-related information, and the UE I uses it to generate request message for continuity of emergency call after handoff occurs;

Here, considering one special situation, that is, UE I pre-stores the emergency call-related information, and it generates said request message for continuity of emergency call according to the pre-stored emergency call-related information each time the handoff occurs. Therefore, understandably, the receiving means 11 and the extracting means 12 are also optional.

Said judging means 13 judges whether the UE I moves from the first type of network, such as WLAN, to a second type of network, such as circuit switched domain network. To be specific, the judging means 13 can send a detecting signal, such as a ranging signal, periodically/non-periodically and actively/passively, and judge whether the UE I has moved out of the first type of network based on the feedbacks. Once the UE I has moved out of the coverage of the first type of network, i.e., the handoff from the first type of network to the circuit switched network has occurred, the continuity of the emergency call is needed; therefore, the judging means 13 notifies this judging result to said generating means 14;

Then, the generating means 14 generates a request message for continuity of emergency call, for example, an A1-interface message. Said request message for continuity of emergency call comprises emergency call-related information, and the contents of said emergency call-related information have the following cases, which are discussed respectively as follows:

Case 1: it Only Comprises Emergency Call Routing Information (The Routing Number of the Emergency Center)

In this case, after the request message for continuity of emergency call sent by UE I reaches MSC (also, the message is forwarded by related network device, for the same reason, without going to details), although MSC can not determine whether the call is emergency call or not, it can successfully routes the message to the emergency center since the message comprises the routing number of the emergency center. When the user is in shutdown state because of owing fee, etc, after MSC receives the request message for continuity of emergency call that only comprises the routing number of the emergency center, it rejects the continuity request since the user is in shutdown state and MSC can not determine whether the call is an emergency call or not, which leads to the failure of the continuity of the emergency call; when the user is not shutdown, MSC routes the request message for continuity of emergency call to the emergency center according to the routing number of the emergency center. Obviously, the emergency indication information in the request message for continuity of emergency call is optional.

Case 2: it Comprises Emergency Call Routing Information and Emergency Call Indication Information

The emergency call indication information in this case has been mentioned above, and it comprises emergency number, such as 110, and/or emergency call identification. MSC can distinguish that the call is an emergency call according to the emergency number or emergency call identification, and thus the MSC still enables the continuity of the call when the user is in shutdown state.

After generating the request message for continuity of emergency call, the generating means 14 delivers it to the sending means 10;

Said sending means 10 sends the generated request message for continuity of emergency call to the network device, to which the UE I belongs, for example a base station, in the second type of wireless network, in which the UE I is currently located.

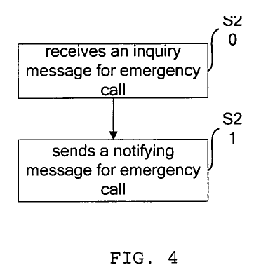

FIG. 4 shows a flow chart of method, in the emergency call control device in wireless communication network, for aiding the continuity of the proceeding emergency call, according to a detailed embodiment of the present invention. Referring to FIG. 4 and combining with FIG. 1, the description is given as follows, and the method is start from step S20;

In step S20, the emergency center II receives an inquiry message for emergency call from the UE I, which is making a proceeding emergency call (such as that UE I has set up an emergency call in a first type of wireless network). Via the inquiry message for emergency call, the emergency center II acknowledges that the UE I needs a notifying message for emergency call, and the method enters step S21;

In step S21, the emergency center II sends the notifying message for emergency call to the UE I, and said notifying message for emergency call comprises emergency call-related information. The sending procedure can be triggered by the inquiry message for emergency call sent by the UE I, or the notifying message can also be actively sent by emergency center II. Therefore, understandable, step S20 is optional.

The contents of the emergency call-related information can be divided into the following several cases, which are discussed respectively as follows:

Case 1: it Only Comprises Emergency Call Routing Information (the Routing Number of the Emergency Center)

In this case, if the UE I does not store the emergency call indication information, then after receiving the notifying message for emergency call, the UE I extracts the only routing number of the emergency center, and generates thereafter a request message for continuity of emergency call that only comprises the routing number of the emergency center. After the request message for continuity of emergency call reaches MSC (also, the message is forwarded by related network device, for the same reason, without going to details), although MSC can not determine whether the call is emergency call or not, it can successfully routes the message to the emergency center since it comprises the routing number of the emergency center. When the UE I is in shutdown state because of owing fee, etc, after MSC receives the request message for continuity of emergency call that only comprises the routing number of the emergency center, MSC rejects the continuity request since the user is in shutdown state and MSC can not determine whether the call is an emergency call or not, which leads to the failure of the continuity of the emergency call; When the user is not shutdown, MSC routes the request message for continuity of emergency call to the emergency center according to the routing number of the emergency center II. Obviously, the emergency indication information is optional in the request message for continuity of emergency call.

Case 2: it Comprises Emergency Call Routing Information and Emergency Call Indication Information

As above-mentioned, the emergency call indication information comprises emergency number, such as 110 and/or emergency call identification. In this case, the UE I needn't pre-store emergency call routing information or emergency call indication information, which can reduce the alterations to the user equipment and thus reduce its cost. The UE I extracts the emergency call routing information and emergency call indication information from said notifying message for emergency call, to generate a request message for continuity of emergency call. Then, the request message for continuity of emergency call, generated by UE I after its handoff from the first type of wireless network to the second type of wireless network occurred, comprises emergency call routing information and emergency call indication information, and the MSC can distinguish that the call is an emergency call according to the emergency call routing information or emergency call indication information, and thus the MSC still enables the continuity of the call when the user is in shutdown state.

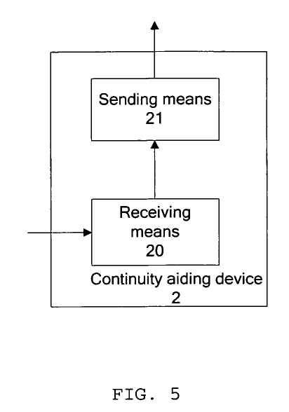

FIG. 5 shows a block diagram for the continuity aiding device, in the emergency call control device in wireless communication network, for aiding the continuity of the proceeding emergency call, according to a detailed embodiment of the present invention. The description is given below referring to FIG. 5 and combining with FIG. 1. The continuity aiding device 2 comprises a receiving means 20 and a sending means 21.

The receiving means 20 receives an inquiry message for emergency call from UE I making a proceeding emergency call, which has already been set up in the first type of wireless network. Via the inquiry message for emergency call, the emergency center II acknowledges that UE I needs a notifying message for emergency call;

Said sending means 21 sends the notifying message for emergency call to the UE I, and said notifying message for emergency call comprises emergency call-related information. The sending procedure can be triggered by the inquiry message for emergency call sent by the UE I, or the notifying message can also be actively sent by the emergency center II. Therefore, understandable, the receiving means 20 is optional.

The contents of the emergency call-related information can be divided into the following several cases, which are discussed respectively as follows:

Case 1: it Only Comprises Emergency Call Routing Information (the Routing Number of the Emergency Center)

In this case, if the UE I does not store the emergency call indication information, then after receiving the notifying message for emergency call, the UE I extracts the only routing number of the emergency center, and generates thereafter a request message for continuity of emergency call that only comprises the routing number of the emergency center. After the request message for continuity of emergency call reaches MSC (also, the message is forwarded by related network device, for the same reason, without going to details), although MSC can not determine whether the call is emergency call or not, it can successfully routes the message to the emergency center since it comprises the routing number of the emergency center. When the UE I is in shutdown state because of owing fee, etc, after MSC receives the request message for continuity of emergency call that only comprises the routing number of the emergency center, MSC rejects the continuity request since the user is in shutdown state and it can not determine whether the call is an emergency call or not, which leads to the failure of the continuity of the emergency call; when the user is not shutdown, MSC routes the request message for continuity of emergency call to the emergency center according to the routing number of the emergency center II. Obviously, the emergency indication information is optional in the request message for continuity of emergency call.

Case 2: it Comprises Emergency Call Routing Information and Emergency Call Indication Information

As above-mentioned, the emergency call indication information comprises emergency number, such as 110, and/or emergency call identification. In this case, the UE I needn't pre-store emergency call routing information or emergency call indication information, which can reduce the alterations to the user equipment and thus reduce its cost. The UE I extracts the emergency call routing information and emergency call indication information from said notifying message for emergency call, to generate the request message for continuity of emergency call. Then, the request message for continuity of emergency call, generated by UE I after its handoff from the first type of wireless network to the second type of wireless network occurred, comprises emergency call routing information and emergency call indication information, and the MSC can distinguish that the call is an emergency call according to the emergency call routing information or emergency call indication information, thus the MSC still enables the continuity of the call when the user is in shutdown state.

The embodiments of the present invention have been described hereinabove. It is understandable that, the present invention is not limited to the above specific embodiment, and those skilled in the art can make various modifications and alterations in the scope of the attached claims.

1. A method, in the user equipment in wireless communication network, for continuing the proceeding emergency call, said method comprises:
a. judging whether said user equipment moves from a first type of wireless network to a second type of wireless network;
b. if said user equipment moves from the first type of wireless network to the second type of wireless network, generating a request message for continuity of emergency call, which comprises the emergency call-related information;
c. sending said request message for continuity of emergency call to a network device, to which said user equipment belongs in the second type of wireless network.

2. The method according to claim 1, further comprising:
receiving a notifying message for emergency call from an emergency call control device, wherein, said notifying message for emergency call comprises emergency call-related information;
extracting said emergency call-related information from said notifying message for emergency call.

3. The method according to claim 2, further comprising:
sending an inquiry message for emergency call to said emergency call control device, to require said emergency call control device to send said notifying message for emergency call to said user equipment.

4. The method according to claim 1, wherein, said emergency call-related information comprises emergency call routing information.

5. The method according to claim 4, wherein, said emergency call-related information further comprises emergency call indication information.

6. The method according to claim 1, wherein, said first type of wireless network is wireless IP network.

7. The method according to claim 6, wherein, said second type of wireless network is wireless circuit switched network.

8. An emergency call continuing device, in the user equipment in wireless communication network, for continuing the proceeding emergency call, comprising:
a judging means, for judging whether said user equipment moves from a first type of wireless network to a second type of wireless network;
a generating means, for if said user equipment moves from the first type of wireless network to the second type of wireless network, generating a request message for continuity of emergency call, which comprises emergency call-related information;
a sending means, for sending said request message for continuity of emergency call to a network device, to which said user equipment belongs in the second type of wireless network.

9. An emergency call continuing device according to claim 8, further comprising:
a receiving means, for receiving a notifying message for emergency call from an emergency call control device, wherein, said notifying message for emergency call comprises emergency call-related information;
an extracting means, for extracting said emergency call-related information from said notifying message for emergency call.

10. The emergency call continuing device according to claim 9, wherein, said sending means is further used for sending an inquiry message for emergency call to said emergency call control device, to require said emergency call control device to send notifying message for emergency call to said user equipment.

11. The emergency call continuing device according to claim 8, wherein, said emergency call-related information comprises emergency call routing information.

12. The emergency call continuing device according to claim 11, wherein, said emergency call-related information further comprises emergency call indication information.

13. The emergency call continuing device according to claim 8, wherein, said first type of wireless network is wireless IP network (such as wireless local area network).

14. The emergency call continuing device according to claim 13, wherein, said second type of wireless network is wireless circuit switched network (such as GSM network).

15. A user equipment, in wireless communication network, for continuing the proceeding emergency call, comprising the emergency call continuing device according to claim 8.

16. A method, in the emergency call control device in wireless communication network, for aiding the continuity of the proceeding emergency call, comprising:
i. sending a notifying message for emergency call to a user equipment, said notifying message for emergency call comprises emergency call-related information.

17. The method according to claim 16, further comprising:
ii. receiving an inquiry message for emergency call from said user equipment;
wherein, said step i further comprises:
according to said inquiry message for emergency call, sending the notifying message for emergency call to said user equipment, said notifying message for emergency call comprises emergency call-related information.

18. A continuity aiding device, in the emergency call control device in wireless communication network, for aiding the continuity of the proceeding emergency call, comprising:
a sending means, for sending a notifying message for emergency call to a user equipment, said notifying message for emergency call comprises emergency call-related information.

19. The continuity aiding device according to claim 18, further comprising:
a receiving means, for receiving an inquiry message for emergency call from said user equipment;
wherein, said sending means is used for according to said inquiry message for emergency call, sending en notifying message for emergency call to said user equipment, said notifying message for emergency call comprises emergency call-related information.

20. A emergency call control device, in the wireless communication network, for aiding the continuity of the proceeding emergency call, comprising the continuity aiding device according to claim 18.
